(19) United States
(12) Patent Application Publication
(10) Pub. No.: US 2017/0060599 A1
(43) Pub. Date: Mar. 2, 2017

(54) METHOD AND APPARATUS FOR AWAKENING ELECTRONIC DEVICE

(71) Applicant: Xiaomi Inc., Beijing (CN)

(72) Inventors: Hong Chen, Beijing (CN); Yi Ding, Beijing (CN); Feiyun Li, Beijing (CN)

(21) Appl. No.: 15/136,997

(22) Filed: Apr. 25, 2016

(30) Foreign Application Priority Data
Aug. 28, 2015 (CN) 201510542949.9

(51) Int. Cl. G06F 9/44; G09G 5/12; G06F 3/0488; G06F 3/0484; G06F 1/32; G06F 3/0481

(52) U.S. Cl. CPC G06F 9/4418; G06F 1/3287; G06F 1/3243; G06F 3/04817; G06F 3/04883; G06F 3/04886; G06F 3/04847; G06F 3/04842; G09G 5/12; H04W 84/12

(57) ABSTRACT

A method and an apparatus for awakening an electronic device are provided. The method includes: receiving a user instruction for awakening an electronic device from its hibernation state and determining an intermediate device. The intermediate device is a device running in a normal operation mode and accessing a same target local area network as the electronic device. The method further includes: sending an awakening instruction to the intermediate device, such that the intermediate device broadcasts in the target local area network an awakening message for awakening the electronic device.

### CROSS-REFERENCE TO RELATED APPLICATIONS

This application is based on and claims priority to Chinese Patent Application No. 201510542949.9, filed on Aug. 28, 2015, the entire contents of which are incorporated herein by reference.

### FIELD

The present disclosure relates to a field of communication technology, and more particularly, to a method and an apparatus for awakening an electronic device.

### BACKGROUND

Currently, an intelligent television may access a router of a local area network via its own wireless fidelity (Wi-Fi) module to obtain Internet video resources. Users may control the television in various manners, such as by an infrared remote controller and a bluetooth remote controller. In the related art, an application program installed in an intelligent terminal, such as a smart home application, may control the intelligent television through the Wi-Fi module of the intelligent television.

A common Wi-Fi module may include a Wi-Fi chip and a major microcontroller unit (MCU) chip. However, when the intelligent television runs in a hibernation mode or a sleep mode, the major MCU chip will enters a hibernation state and the Wi-Fi chip will enter a low power state in order to reduce the power consumption, which may make the Wi-Fi module stop working. In such a case, the users cannot remotely open the intelligent television via the smart home application, which causes inconvenience.

### SUMMARY

Accordingly, embodiments of the present disclosure provide a method for awakening an electronic device and an apparatus for awakening an electronic device. According to the embodiments of the present disclosure, it can remotely awake an electronic device in a hibernation mode, thus solving the problem of inconvenience.

According to a first aspect of embodiments of the present disclosure, there is provided a method for awakening an electronic device. The method includes: receiving a user instruction for awakening an electronic device from its hibernation state and determining an intermediate device. The intermediate device is a device running in a normal operation mode and accessing a same target local area network as the electronic device. The method further includes: sending an awakening instruction to the intermediate device, such that the intermediate device broadcasts in the target local area network an awakening message for awakening the electronic device.

According to a second aspect of embodiments of the present disclosure, there is provided an apparatus for awakening an electronic device. The apparatus includes: a processor; and a memory configured to store an instruction executable by the processor. The processor is configured to perform: receiving a user instruction for awakening an electronic device from its hibernation state and determining an intermediate device. The intermediate device is a device running in a normal operation mode and accessing a same target local area network as the electronic device. The processor is further configured to perform: sending an awakening instruction to the intermediate device, such that the intermediate device broadcasts in the target local area network an awakening message for awakening the electronic device.

According to a third aspect of embodiments of the present disclosure, there is provided a non-transitory computer-readable storage medium having stored therein instructions that, when executed by a processor of an apparatus, causes the apparatus to perform a method for awakening an electronic device. The method includes: receiving a user instruction for awakening an electronic device from its hibernation state and determining an intermediate device. The intermediate device is a device running in a normal operation mode and accessing a same target local area network as the electronic device. The method further includes: sending an awakening instruction to the intermediate device, such that the intermediate device broadcasts in the target local area network an awakening message for awakening the electronic device.

According to the embodiments of the present disclosure, the technical solution may result in the following advantageous effects.

In the embodiments of the present disclosure, when the apparatus detects an electronic device that enters a hibernation mode, the electronic device will select an intermediate device in the same target local area network as the electronic device, and send an awakening instruction to the intermediate device, such that the intermediate device broadcasts an awakening message for awakening the electronic device in the target local area network according to the awakening instruction. Through the above process, the apparatus may remotely awaken the electronic device that enters the hibernation state, which brings about great convenience.

In the embodiments of the present disclosure, the apparatus may maintain the correspondence relationship between a local area network and at least one device accessing the local area network in advance, and then select the intermediate device that accesses the target local area network according to the correspondence relationship, so as to send the awakening instruction to the intermediate device and to achieve the purpose of remotely awakening the electronic device that enters the hibernation state, which brings about great convenience.

In the embodiments of the present disclosure, the Wi-Fi chip of the electronic device may receive the awakening message broadcasted by the intermediate device via the target local area network, so as to awaken the major MCU chip of the electronic device according to the received awakening message. In such a way, it is possible to achieve the purpose of remotely awakening the electronic device that enters the hibernation state and to bring about great convenience thereby.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a method for awakening an electronic device according to an exemplary embodiment of the present disclosure.

FIG. 2 is a flow chart showing another method for awakening an electronic device according to an exemplary embodiment of the present disclosure.

FIG. 3 is a flow chart showing another method for awakening an electronic device according to an exemplary embodiment of the present disclosure.

FIG. 4 is a flow chart showing another method for awakening an electronic device according to an exemplary embodiment of the present disclosure.

FIG. 5 is a flow chart showing another method for awakening an electronic device according to an exemplary embodiment of the present disclosure.

FIGS. 6A to 6C are schematic diagrams illustrating user interfaces for awakening an electronic device according to an exemplary embodiment of the present disclosure.

FIG. 7 is a block diagram showing an apparatus for awakening an electronic device according to an exemplary embodiment of the present disclosure.

FIG. 8 is a block diagram showing another apparatus for awakening an electronic device according to an exemplary embodiment of the present disclosure.

FIG. 9 is a block diagram showing another apparatus for awakening an electronic device according to an exemplary embodiment of the present disclosure.

FIG. 10 is a block diagram showing another apparatus for awakening an electronic device according to an exemplary embodiment of the present disclosure.

FIG. 11 is a block diagram showing another apparatus for awakening an electronic device according to an exemplary embodiment of the present disclosure.

FIG. 12 is a block diagram showing another apparatus for awakening an electronic device according to an exemplary embodiment of the present disclosure.

FIG. 13 is a block diagram showing another apparatus for awakening an electronic device according to an exemplary embodiment of the present disclosure.

FIG. 14 is a block diagram showing another apparatus for awakening an electronic device according to an exemplary embodiment of the present disclosure.

FIG. 15 is a block diagram showing another apparatus for awakening an electronic device according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items.

It shall be understood that terms such as “first,” “second,” and “third” may be used to describe various information in the present disclosure, but the information are not limited to the terms which are used to distinguish information of the same type from each other. For example, first information may be called second information, and similarly, the second information may be called the first information, without departing from the scope of the present disclosure. As used herein, the term “if” may be construed to mean “when” or “upon” or “in response to determining” depending on the context.

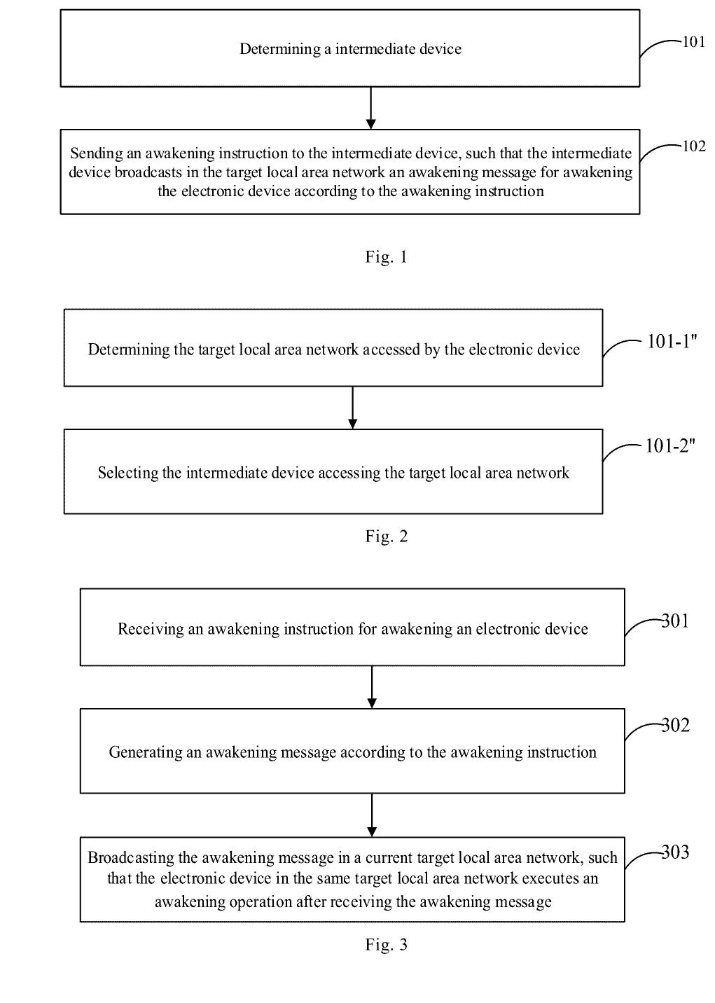

As shown in FIG. 1 that is a flow chart showing a method for awakening an electronic device according to an exemplary embodiment of the present disclosure, the method includes the following steps.

In step 101, an intermediate device is determined upon receiving a user instruction for awakening an electronic device from its hibernation state. Herein, the intermediate device is a device running in a normal operation mode and accessing a same target local area network as the electronic device in the hibernation state.

The methods provided in embodiments of the present disclosure is implemented by an apparatus. The apparatus may be an intelligent terminal, such as a smart phone, a tablet computer and a personal digital assistant (PAD). The electronic device in the hibernation state or the electronic device to be awakened (referred as “electronic device” in the following description) may be an intelligent device provided with a Wi-Fi module, such as an intelligent television.

Alternatively, it is possible to determine the intermediate device in any one of the following ways.

For example, the apparatus may determine the intermediate device after an awakening button is selected.

The step 101 may include step 101-1 of receiving a user instruction for awakening an electronic device in response to a detected selection of the awakening button for awakening the electronic device.

In step 101-1, the apparatus may detect whether the awakening button is selected through the related technology. Alternatively, the awakening button is a virtual button for controlling an interface of the electronic device. When the awakening button is selected, the apparatus will proceed with the step of determining the intermediate device.

In some alternative embodiments, when the awakening button is selected, the apparatus would search the target local area network at which the electronic device is located, and select the intermediate device. In some alternative embodiments, the intermediate device could be selected based on the signal strength. For example, in order to achieve a better effect for broadcasting the awakening message, a device with a maximum signal transmission strength will be selected as the intermediate device from at least one device accessing the target local area network. In some alternative embodiments, the intermediate device could be selected based on the intensity of communication between the intermediate device and the electronic device. For example, a device having a maximum intensity of communication with the electronic device will be selected as the intermediate device among the at least one device accessing the target local area network.

In some alternative embodiments, the corresponding relationship between the electronic device and the target local area network could either be stored in a memory of the electronic device or be stored in a server or cloud for the electronic device to read. When the awakening button is selected, the electronic device could search the target local area network according to the corresponding relationship, and select the intermediate device.

Alternatively, the apparatus may determine the intermediate device after an icon is clicked.

The step 101 may include step 101-1′ of determining the intermediate device in response to a detected presence of a user's touch on the icon for awakening the electronic device.

In step 101-1′, the user may click the icon preset in the apparatus. Alternatively, the icon is a virtual slider icon for controlling an interface of the electronic device. When the apparatus detects the presence of a user touching the icon, the method will proceed with a step of determining the intermediate device.

In the embodiment of the present disclosure, the process of determining the intermediate device is further as shown in FIG. 2. FIG. 2 is a flow chart showing another method for awakening an electronic device according to an exemplary embodiment of the present disclosure. The method includes the following steps.

In step 101-1″, the target local area network accessed by the electronic device is determined according to a preset correspondence relationship between a local area network and at least one device accessing the local area network.

In this step, the apparatus stores the correspondence relationship between the local area network and the at least one device accessing the local area network in advance, and first determines the target local area network accessed by the electronic device according to the preset correspondence relationship.

In step 101-2″, the intermediate device that accesses the target local area network is determined according to the correspondence relationship.

After the target local area network is determined, the intermediate device that also accesses the target local area network is further determined according to the correspondence relationship.

In step 102, an awakening instruction is sent to the intermediate device, such that the intermediate device broadcasts in the target local area network an awakening message for awakening the electronic device according to the awakening instruction.

In this step, the apparatus generates the awakening instruction through the related technology and sends the awakening instruction to the intermediate device, after determining the intermediate device.

The intermediate device generates the awakening message through the related technology according to the received awakening instruction. Alternatively, the awakening message is a Wi-Fi awakening message received by a Wi-Fi chip that enters a low-power state in the related art. The intermediate device may broadcast the awakening message in the target local area network to ensure that the electronic device may receive the Wi-Fi awakening message.

After the electronic device enters the hibernation state, a major MCU chip thereof will enter the hibernation state and the Wi-Fi chip thereof will enter the low power state. The major MCU chip of the electronic device is preset its own mechanism of being awakened, which may be in such a way that the major MCU chip will not be awakened until the Wi-Fi chip of the electronic device receives the Wi-Fi awakening message. The electronic device may receive the awakening message broadcasted by the intermediate device in the same local area network via the Wi-Fi chip, and hence awaken the major MCU chip according to the awakening message.

The above process may be realized by a device control application installed in the apparatus in advance. The device control application is logged in by a device identifier of the apparatus. When the device control application detects that the virtual awakening button is selected or the virtual slider icon is clicked, the target local area network accessed by the electronic device is determined first according to the preset correspondence relationship, and the intermediate device that also accesses the target local area network is determined according to the correspondence relationship.

The device control application generates and sends the awakening instruction to the intermediate device through the related technology. The intermediate device generates the Wi-Fi awakening message through the related technology according to the awakening instruction, and broadcasts the Wi-Fi awakening message to ensure that the electronic device may receive the Wi-Fi awakening message. The Wi-Fi chip of the electronic device awakens its own major MCU chip according to the awakening message after receiving the Wi-Fi awakening message broadcasted by the intermediate device.

In some embodiments, the IP address of the intermediate device and/or the electronic device could be embedded into the awakening instruction. In alternative embodiments, the IP address of the electronic device could be embedded into the header of the Wi-Fi awakening message.

In the above embodiment, when the apparatus detects necessity of awakening the electronic device from the hibernation state, the apparatus will determine the intermediate device in the same target local area network as the electronic device, and then send the awakening instruction to the intermediate device, such that the intermediate device broadcasts in the target local area network the awakening message for awakening the electronic device according to the awakening instruction. The above process achieves the purpose of remotely awakening the electronic device from the hibernation state, which brings about great convenience.

As shown in FIG. 3 that is a flow chart showing another method for awakening an electronic device according to an exemplary embodiment of the present disclosure. The method includes the following steps.

In step 301, an awakening instruction for awakening an electronic device is received.

In this step, an intermediate device may receive the awakening instruction sent by the apparatus through the related technology.

In step 302, an awakening message is generated according to the awakening instruction.

The intermediate device generates the awakening message through the related technology according to the received awakening instruction. Alternatively, the awakening message is the Wi-Fi awakening message in the related technology, and the Wi-Fi chip of the electronic device still can receive the Wi-Fi awakening message even if it enters the low power state.

In step 303, the awakening message is broadcasted in a current target local area network, such that the electronic device in the same target local area network executes an awakening operation after receiving the awakening message.

In order to ensure that the electronic device may receive the Wi-Fi awakening message, the intermediate device may broadcast the awakening message in the current target local area network, and the major MCU chip of the electronic device is awakened according to the Wi-Fi awakening message after the Wi-Fi chip thereof receives the Wi-Fi awakening message.

In the above embodiment, the intermediate device may receive the awakening instruction, generate the Wi-Fi awakening message automatically and broadcast the awakening message in the current local area network. Then the major MCU chip of the electronic device is awakened after the electronic device in the same local area network receives the awakening message. The above process achieves the purpose of remotely awakening the electronic device from the hibernation state, which brings about great convenience.

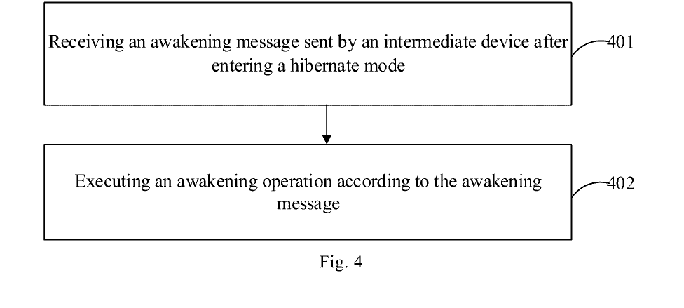

As shown in FIG. 4 that is a flow chart showing another method for awakening an electronic device according to an exemplary embodiment of the present disclosure. The method includes the following steps.

In step 401, an awakening message sent by an intermediate device is received after entering a hibernation state, in which an electronic device is in a same target local area network as the intermediate device. The awakening message is a message broadcasted in the target local area network after the intermediate device receives an awakening instruction.

Before this step, the apparatus sends the awakening instruction to the intermediate device in the same target local area network as the electronic device in the above method, such that the intermediate device generates the awakening message according to the awakening instruction and broadcasts the awakening message in the target local area network.

Since the electronic device has entered the hibernation state, it is alternative to send the message to the Wi-Fi chip of the electronic device in the low power state. Alternatively, the awakening message is a Wi-Fi awakening message. Correspondingly, the step 401 may include step 401-1 of receiving the Wi-Fi awakening message sent by the intermediate device via the Wi-Fi chip of the electronic device.

The Wi-Fi chip of the electronic device may receive the Wi-Fi awakening message through the related technology to execute an awakening operation in the subsequent step.

In step 402, the awakening operation is executed according to the awakening message.

Alternatively, the step 402 may include step 402-1 of awakening a major MCU chip of the electronic device according to the awakening message.

The major MCU chip of the electronic device is preset its own mechanism of being awakened, which may be in such a way that the major MCU chip will not be awakened until the Wi-Fi chip of the electronic device receives the Wi-Fi awakening message. In this step, the Wi-Fi chip may awaken the major MCU chip according to the awakening message through the related technology. Then, the electronic device may start working normally.

In the above embodiment, the Wi-Fi chip of the electronic device may receive the awakening message broadcast by the intermediate device in the target local area network, such that the major MCU chip of the electronic device is awakened according to the received awakening message. Consequently, it is possible to remotely awaken the electronic device from the hibernation state, which brings about great convenience.

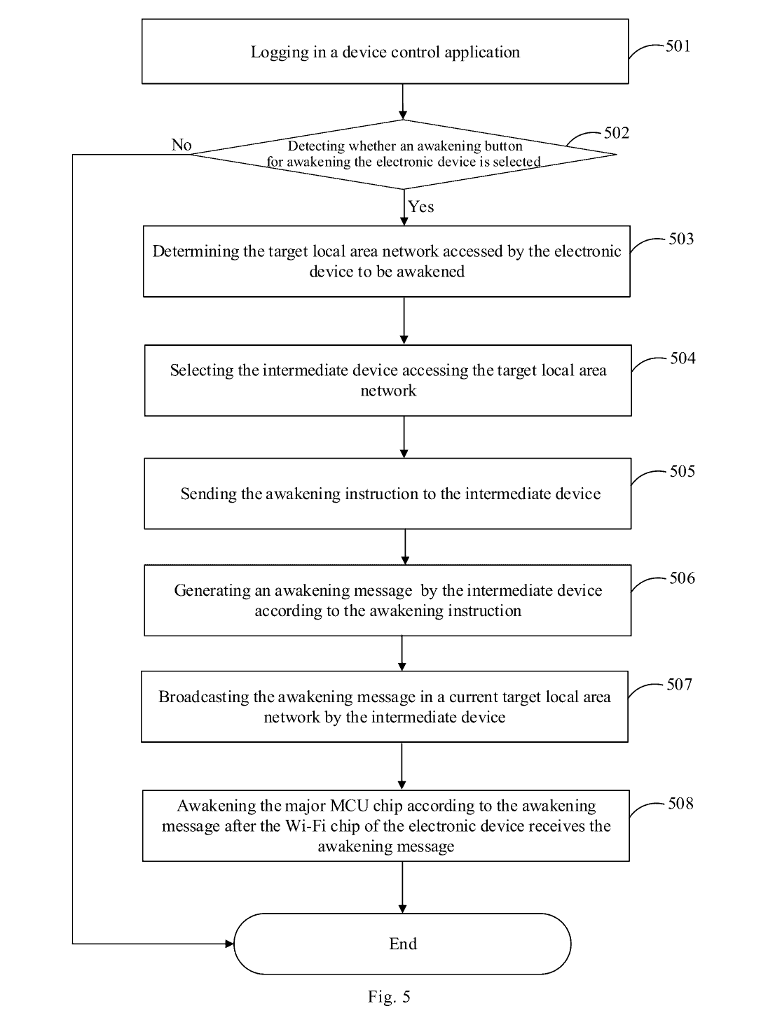

As shown in FIG. 5 that is a flow chart showing another method for awakening an electronic device according to an exemplary embodiment of the present disclosure. The method includes the following steps.

In step 501, a device control application is logged in by a device identifier of apparatus.

In this step, the device control application pre-installed in the apparatus may be logged in by the device identifier (like phone number) through the related technology.

In step 502, the device control application detects whether an awakening button for awakening the electronic device is selected. When the awakening button is selected, step 503 is executed. Otherwise the process of awakening the electronic device is terminated.

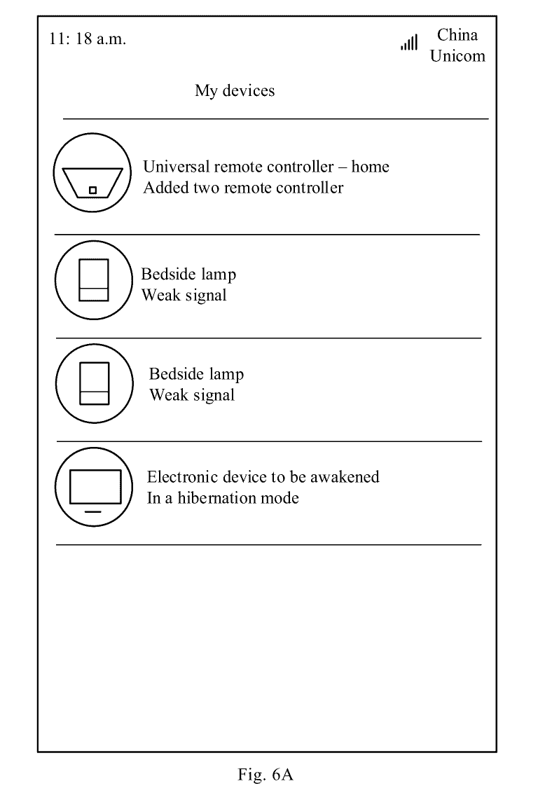

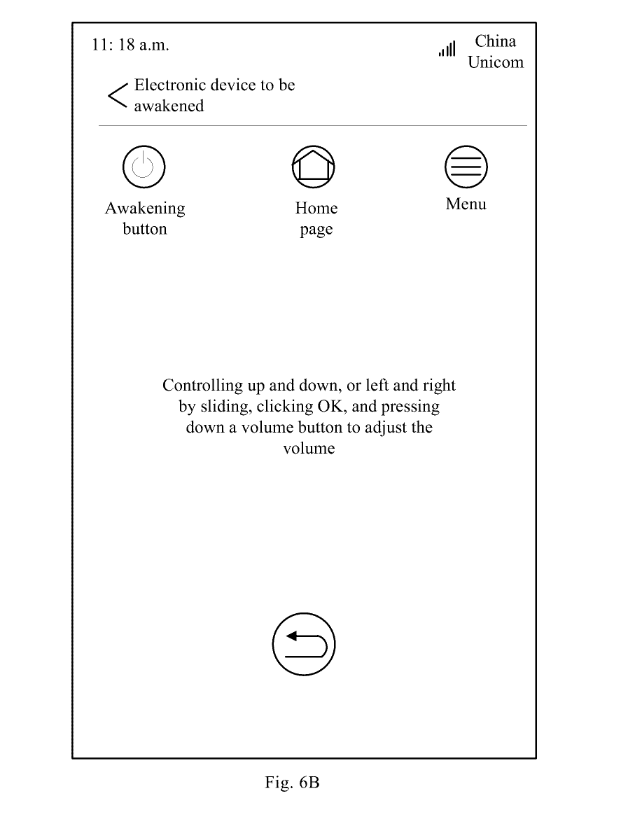

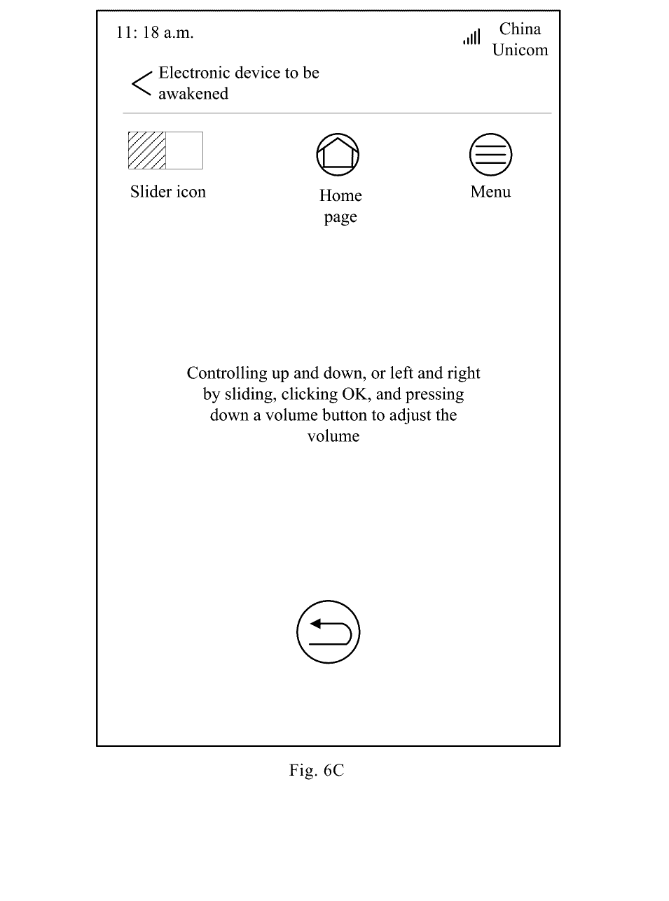

After the device control application is logged in, a list of all devices controlled by the apparatus will be displayed in the interface, as shown in FIG. 6A. The user may click the electronic device in the above list to open a control interface corresponding to the electronic device, and a virtual awakening button is provided on the interface for controlling the electronic device, as shown in FIG. 6B. The apparatus may detect whether the user has selected the awakening button through the related art. When the awakening button is selected, it is determined that the user needs to awaken the electronic device remotely via the apparatus, and step 503 is executed.

Of course, the step may be implemented in other ways. For example, after the control interface corresponding to the electronic device is opened by the apparatus, a virtual slider icon may be provided in the control interface of the apparatus, as shown in FIG. 6C. The apparatus may detect whether a user touches the slider icon through the related technology. When the touch is detected, it may also be determined that the user needs to awaken the electronic device remotely via the apparatus, and step 503 is executed.

In step 503, the device control application determines the target local area network accessed by the electronic device according to a preset correspondence relationship between a local area network and at least one device accessing the local area network.

In step 504, the device control application selects the intermediate device accessing the target local area network according to the correspondence relationship.

In step 505, the device control application sends the awakening instruction to the intermediate device.

In this step, the electronic device generates the awakening instruction through the related technology, and sends the awakening instruction to the intermediate device, after determining the intermediate device.

In step 506, the intermediate device generates an awakening message according to the awakening instruction.

Alternatively, the awakening message is the Wi-Fi awakening message in the related technology, and the Wi-Fi chip of the electronic device still can receive the Wi-Fi awakening message even if it enters the low power state.

In step 507, the target device broadcasts the awakening message in a current target local area network.

In order to ensure that the electronic device may receive the awakening message, the intermediate device may broadcast the awakening message in the current target local area network.

In step 508, the major MCU chip is awakened according to the awakening message after the Wi-Fi chip of the electronic device receives the awakening message.

The major MCU chip of the electronic device is preset its own mechanism of being awakened, which may be in such a way that the major MCU chip will not be awakened until the Wi-Fi chip of the electronic device receives the Wi-Fi awakening message. The Wi-Fi chip may awaken the major MCU chip according to the awakening message through the related technology, after receiving the Wi-Fi awakening message. Then, the electronic device may start working normally.

Further exemplification for the above process is presented as follows.

The user logs in the device control application pre-installed in the apparatus by the device identifier of the apparatus. The main control interface may display a list of all devices controlled by the apparatus, as shown in FIG. 6A. The user may click the electronic device in the above list to open the control interface corresponding to the electronic device, and the virtual awakening button is provided on the interface for controlling the electronic device, as shown in FIG. 6B. The apparatus may detect whether the user has selected the awakening button through the related technology. Alternatively, after the apparatus opens the control interface corresponding to the electronic device, the virtual slider icon may be provided in the control interface of the electronic device, as shown in FIG. 6C. The apparatus may detect whether there is a user's touch on the slider icon through the related technology.

When the user selects the awakening button or clicks the slider icon, the device control application first determines the target local area network accessed by the electronic device according to the preset correspondence relationship, and determines the intermediate device that also accesses the target local area network according to the correspondence relationship. The device control application generates the awakening message through the related technology and sends it to the intermediate device; the intermediate device generates the Wi-Fi awakening message through the related technology according to the awakening instruction, and broadcasts the Wi-Fi awakening message in the target local area network to ensure that the electronic device may receive the Wi-Fi awakening message. The Wi-Fi chip of the electronic device awakens the major MCU chip according to the awakening message after receiving the Wi-Fi awakening message broadcast by the intermediate device.

Corresponding to the previous method embodiments of awakening the electronic device, the present disclosure further provides an embodiment of an apparatus for awakening an electronic device.

As shown in FIG. 7 that is a block diagram showing an apparatus for awakening an electronic device according to an exemplary embodiment of the present disclosure, the apparatus includes an obtaining module 710 and a sending module 720.

The obtaining module 710 is configured to determine upon receiving a user instruction for awakening an electronic device from its hibernation state. Herein, the intermediate device is a device running in a normal operation mode and accessing a same target local area network as the electronic device in the hibernation state.

The sending module 720 is configured to send an awakening instruction to the intermediate device determined by the obtaining module 710, such that the intermediate device broadcasts in the target local area network an awakening message for awakening the electronic device according to the awakening instruction.

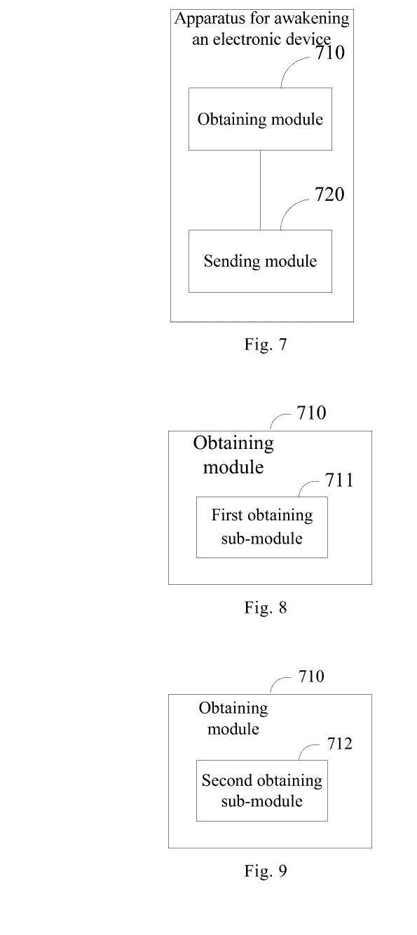

As shown in FIG. 8 that is a block diagram showing another apparatus for awakening an electronic device according to an exemplary embodiment of the present disclosure, this embodiment is based on the embodiment shown in FIG. 7. The obtaining module 710 includes: a first obtaining sub-module 711.

The first obtaining sub-module 711 is configured to determine the intermediate device in response to a detected selection of an awakening button for awakening the electronic device.

In the above embodiment, the awakening button is a virtual button for controlling an interface of the electronic device.

As shown in FIG. 9 that is a block diagram showing another apparatus for awakening an electronic device according to an exemplary embodiment of the present disclosure, this embodiment is based on the embodiment shown in FIG. 7. The obtaining module 710 includes: a second obtaining sub-module 712.

The second obtaining sub-module 712 is configured to determine the intermediate device in response to a detected presence of a user's touch on an icon for awakening the electronic device.

In the above embodiment, the icon is a virtual slider icon for controlling an interface of the electronic device.

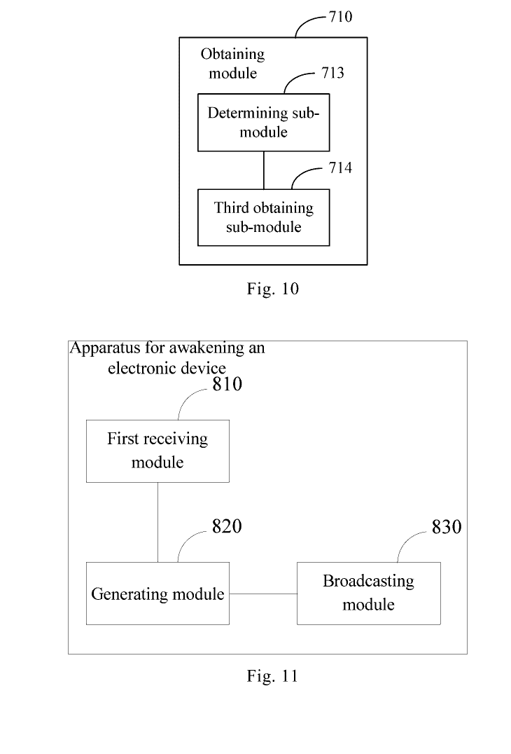

As shown in FIG. 10 that is a block diagram showing another apparatus for awakening an electronic device according to an exemplary embodiment of the present disclosure, this embodiment is based on the embodiment shown in FIG. 7. The obtaining module 710 includes: a determining sub-module 713 and a third obtaining sub-module 714.

The determining sub-module 713 is configured to determine the target local area network accessed by the electronic device according to a preset correspondence relationship between a local area network and at least one device accessing the local area network.

The third obtaining sub-module 714 is configured to determine the intermediate device accessing the target local area network determined by the determining sub-module 713 according to the correspondence relationship.

As shown in FIG. 11 that is a block diagram showing another apparatus for awakening an electronic device according to an exemplary embodiment of the present disclosure, the apparatus includes a first receiving module 810, a generating module 820 and a broadcasting module 830.

The first receiving module 810 is configured to receive an awakening instruction for awakening an electronic device.

The generating module 820 is configured to generate an awakening message according to the awakening instruction received by the first receiving module.

The broadcasting module 830 is configured to broadcast the awakening message generated by the generating module in a current target local area network, such that the electronic device in the same target local area network executes an awakening operation after receiving the awakening message.

In the above embodiment, the awakening message is a Wi-Fi awakening message.

In the above embodiment, the intermediate device may generate the Wi-Fi awakening message automatically and broadcast it by the current local area network according to the received awakening instruction. Then, the electronic device in the same target local area network awakens the major MCU chip after receiving the Wi-Fi awakening message. The above process achieves the purpose of remotely awakening the electronic device from the hibernation state, which brings about great convenience.

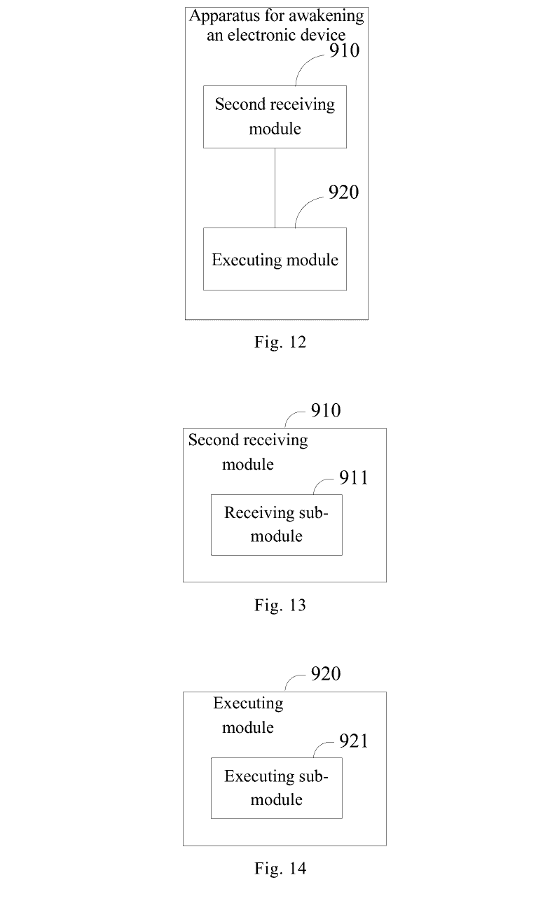

As shown in FIG. 12 that is a block diagram showing another apparatus for awakening an electronic device according to an exemplary embodiment of the present disclosure, the apparatus includes a second receiving module 910 and an executing module 920.

The second receiving module 910 is configured to receive an awakening message sent by a intermediate device after entering a hibernation state, in which an electronic device is in a same target local area network as the intermediate device, and the awakening message is a message broadcast in the target local area network after the intermediate device receives an awakening instruction.

The executing module 920 is configured to execute an awakening operation according to the awakening message received by the second receiving module.

As shown in FIG. 13 that is a block diagram showing another apparatus for awakening an electronic device according to an exemplary embodiment of the present disclosure, this embodiment is based on the embodiment shown in FIG. 12. The second receiving module 910 includes: a receiving sub-module 911.

The receiving sub-module 911 is configured to receive the awakening message sent by the intermediate device via a Wi-Fi chip of the electronic device.

As shown in FIG. 14 that is a block diagram showing another apparatus for awakening an electronic device according to an exemplary embodiment of the present disclosure, this embodiment is based on the embodiment shown in FIG. 12.

The executing module 920 includes: an executing sub-module 921.

The executing sub-module 921 is configured to awaken a major MCU chip of the electronic device according to the awakening message received by the second receiving module.

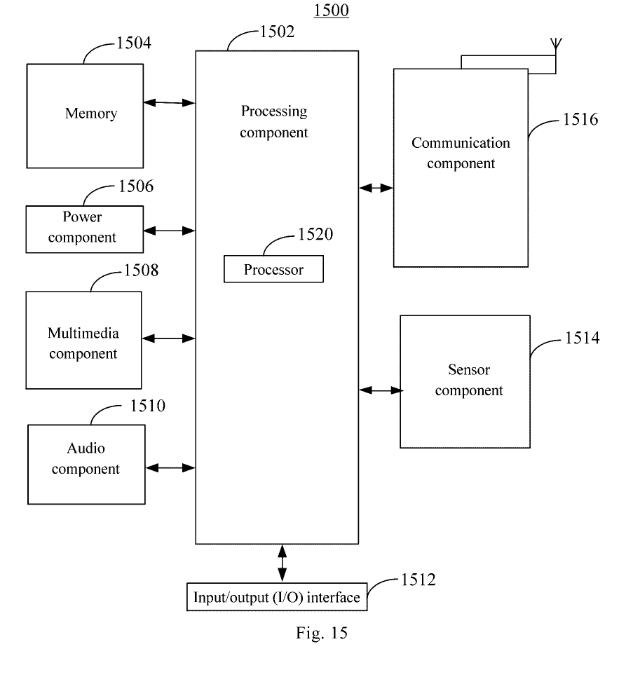

As shown in FIG. 15 that is a block diagram showing another apparatus 1500 for awakening an electronic device according to an exemplary embodiment of the present disclosure. For example, the apparatus 1500 may be an electronic device, like an intelligent terminal that may be a mobile phone, a computer, a digital broadcasting terminal, message sending and receiving equipment, a smart power plug, a smart sphygmomanometer, a game controller, a tablet device, a medical device, fitness equipment and a personal digital assistant.

Referring to FIG. 15, the apparatus 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls overall operations of the apparatus 1500, such as the operations associated with display, telephone calls, data communications, camera operations, and recording operations. The processing component 1502 may include one or more processors 1520 to execute instructions to perform all or part of the steps in the above described methods. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the apparatus 1500. Examples of such data include instructions for any applications or methods operated on the apparatus 1500, contact data, phonebook data, messages, pictures, video, etc. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the apparatus 1500. The power component 1506 may include a power management system, one or more power sources, and any other components associated with the generation, management, and distribution of power in the apparatus 1500.

The multimedia component 1508 includes a screen providing an output interface between the apparatus 1500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 15015 includes a front camera and/or a rear camera. The front camera and the rear camera may receive an external multimedia datum while the apparatus 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone (“MIC”) configured to receive an external audio signal when the apparatus 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the apparatus 1500. For instance, the sensor component 1514 may detect an open/closed status of the apparatus 1500, relative positioning of components, e.g., the display and the keypad, of the apparatus 1500, a change in position of the apparatus 1500 or a component of the apparatus 1500, a presence or absence of user contact with the apparatus 1500, an orientation or an acceleration/deceleration of the apparatus 1500, and a change in temperature of the apparatus 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor.

The communication component 1516 is configured to facilitate communication, wired or wirelessly, between the apparatus 1500 and other devices. The apparatus 1500 can access a wireless network based on a communication standard, such as WiFi, 2G or 3G or a combination thereof. In one exemplary embodiment, the communication component 1516 receives a broadcast signal or broadcast associated information from an external broadcast management system via a broadcast channel. In one exemplary embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1504, executable by the processor 1520 in the apparatus 1500, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the above embodiments are preferred embodiments of the present disclosure and cannot be constructed to limit the present disclosure, and that various modifications, equal alternatives and improvements can be made without departing from the scope thereof.

What is claimed is:

1. A method for awakening an electronic device, comprising:
receiving a user instruction for awakening an electronic device from its hibernation state;
determining an intermediate device, the intermediate device being a device running in a normal operation mode and accessing a same target local area network as the electronic device; and
sending an awakening instruction to the intermediate device, such that the intermediate device broadcasts in the target local area network an awakening message for awakening the electronic device.

2. The method according to claim 1, wherein the user instruction is received when a user selects an awakening button for awakening the electronic device.

3. The method according to claim 2, wherein the awakening button is a virtual button for controlling an interface of the electronic device.

4. The method according to claim 1, wherein the user instruction is received when a user touches an icon for awakening the electronic device.

5. The method according to claim 4, wherein the icon is a virtual slider icon for controlling an interface of the electronic device.

6. The method according to claim 1, wherein determining the intermediate device comprises:
determining the target local area network accessed by the electronic device according to a preset correspondence relationship between a local area network and at least one device accessing the local area network; and
selecting one of the at least one device accessing the target local area network as the intermediate device.

7. The method according to claim 6, wherein a device with a maximum signal transmission strength is selected as the intermediate device from the at least one device accessing the target local area network.

8. The method according to claim 6, wherein a device having a maximum intensity of communication with the electronic device will be selected as the intermediate device from the at least one device accessing the target local area network.

9. An apparatus for awakening an electronic device, comprising:
a processor; and
a memory configured to store an instruction executable by the processor;
wherein the processor is configured to perform:
receiving a user instruction for awakening an electronic device from its hibernation state;
determining an intermediate device, the intermediate device being a device running in a normal operation mode and accessing a same target local area network as the electronic device; and
sending an awakening instruction to the intermediate device, such that the intermediate device broadcasts in the target local area network an awakening message for awakening the electronic device.

10. The apparatus according to claim 9, wherein the user instruction is received when a user selects an awakening button for awakening the electronic device.

11. The apparatus according to claim 10, wherein the awakening button is a virtual button for controlling an interface of the electronic device.

12. The apparatus according to claim 9, wherein the user instruction is received when a user touches an icon for awakening the electronic device.

13. The apparatus according to claim 12, wherein the icon is a virtual slider icon for controlling an interface of the electronic device.

14. The apparatus according to claim 9, wherein determining the intermediate device comprises:
determining the target local area network accessed by the electronic device according to a preset correspondence relationship between a local area network and at least one device accessing the local area network; and
selecting one of the at least one device accessing the target local area network as the intermediate device.

15. The apparatus according to claim 9, wherein the intermediate device is configured to receive the awakening instruction for awakening the electronic device, to generate the awakening message according to the awakening instruction, and to broadcast the awakening message in the target local area network, such that the electronic device executes an awakening operation after receiving the awakening message.

16. The apparatus according to claim 9, wherein the electronic device is configured to receive the awakening message during the hibernation state and execute an awakening operation according to the awakening message.

17. The apparatus according to claim 14, wherein a device with a maximum signal transmission strength is selected as the intermediate device from the at least one device accessing the target local area network.

18. The apparatus according to claim 14, wherein a device having a maximum intensity of communication with the electronic device will be selected as the intermediate device from the at least one device accessing the target local area network.

19. A non-transitory computer-readable storage medium having stored therein instructions that, when executed by a processor of an apparatus, causes the apparatus to perform a method for awakening an electronic device, the method comprising:
receiving a user instruction for awakening an electronic device from its hibernation state;
determining an intermediate device, the intermediate device being a device running in a normal operation mode and accessing a same target local area network as the electronic device; and
sending an awakening instruction to the intermediate device, such that the intermediate device broadcasts in the target local area network an awakening message for awakening the electronic device.
